(19) United States
(12) Patent Application Publication
(10) Pub. No.: US 2014/0251499 A1
(43) Pub. Date: Sep. 11, 2014

(54) METHODS AND SYSTEMS OF MANAGING CHIPPING AND SAWING EQUIPMENT

(71) Applicant: WEYERHAEUSER NR COMPANY, Federal Way, WA (US)

(72) Inventor: Earl Barker, Enumclaw, WA (US)

(73) Assignee: WEYERHAEUSER NR COMPANY, Federal Way, WA (US)

(21) Appl. No.: 14/189,812

(22) Filed: Feb. 25, 2014

Related U.S. Application Data
(60) Provisional application No. 61/772,804, filed on Mar. 5, 2013.

(51) Int. Cl. B27B 31/00; B23Q 17/22

(52) U.S. Cl. CPC B27B 31/006; B23Q 17/22
USPC 144/356; 144/402

(57) ABSTRACT

At least one image device proximate a second conveyor is disposed a predetermined distance in front of chip heads. The at least one image device can image a log and capture the actual log position on a sharp chain before its being engaged by chip heads. A computing device is coupled to the at least one image device to receive data including the actual log position information. The computing device compares the actual log position to a preferred log position solution so as to check whether a log deviates from its expected position. If any position deviation exists, the computing device may send instructions to adjust the positions of the chip heads and saws to ensure that a log is correctly positioned relative to the chip heads and saws, whereby correcting log position errors and eliminating transport accuracy losses.

### CROSS REFERENCE TO RELATED APPLICATIONS

This application claims priority to U.S. provisional Application No. 61/772,804 filed Mar. 5, 2013, the contents of which are incorporated herein.

### DESCRIPTION OF THE RELATED ART

The lumber mill industry has become largely automated. Full length tree trunks are delivered to sawmills, where they are automatically debarked, scanned, and cut into log segments based on their scanned geometry. These log segments are then typically processed at a number of automated stations, depending on sawmills and types of wood. These processing stations produce lumber from each log segment, often without any human intervention.

U.S. Pat. No. 8,229,803 disclosed a sawmill system 100 substantially as shown in FIG. 1. The sawmill system 100 includes one or more bucking saws 122, log sort decks 126, a primary breakdown machinery 124, a gangsaw/resaw 128, an edger 130, a trimmer 132, a sorter 134, and one or more scan zones 106, 108, 110, 112, and/or 114 where acquisition devices (e.g., laser scanners, imagers such as camera) are installed.

While omitted from FIG. 1, it is recognized that the sawmill system 100 may include one or more optimizers in conjunction with one or more pieces of equipment (e.g., the bucking saws 122, the primary breakdown machinery 124, the gangsaw/resaws 128, the edger 130, and/or the trimmer 110). The optimizers analyze information about the input (e.g., log segments, cants, boards) of a set of operations (e.g., sawing), and automatically determine a number of parameters intended to optimize the operations, for example, to produce an optimized output. The optimizers typically include the one or more acquisition devices to acquire information from logs, cants or boards, and one or more computers programmed to process and/or analyze the acquired information and produce an optimized solution that is intended to optimize an output of the operation(s).

As illustrated in FIG. 1, the sawmill system 100 receives full length tree trunks at 118. These full length tree trunks or logs may be debarked and then scanned at a 3D stem scanner 120. The 3D stem scanner 120 may be implemented as one or a plurality of planar laser scanners that generate image data along the length of each log. The image data for the logs may then be analyzed by a computer optimizer (not shown) in order to determine how best to saw or “buck up” the logs into log segments.

This process of deciding how to buck up a log into log segments is called merchandizing. In one embodiment, the computer optimizer performing the merchandizing uses a brute force simulation of all possible bucking options, simulating in addition all of the downstream sawing processes that will take place inside the sawmill system 100 (e.g., primary breakdown, cant processing, and edging). The merchandizing computer optimizer may also take into account the processing time for each individual log segment, the current market values for particular pieces of lumber, the effect of log sleep (or curvature) on recovery, etc.

After the merchandizing computer optimizer has determined how to buck up a particular log, the log may then be driven transversely or lineally through the one or more bucking saws 122 so as to be bucked up into log segments. The bucking saws 122 may be controlled by a programmable logic controller (PLC) or other automated system, which may in turn be controlled by the merchandizing computer optimizer.

After the bucking process, the log segments may be sorted, for example, by species, size and intended end use, at the log sort decks 126 prior to further processing. Then, the log segments may be transported to the primary breakdown machinery 124. Upstream from the primary breakdown machinery 124, the log segments may be scanned at a log segment scan zone 106. The primary breakdown machinery 124 processes the log segments to produce cants and may include chip heads for removing slab wood as well as one or more saws (e.g. round saws or band saws) for sawing sideboards from the cants. A primary breakdown scan zone 108 may be positioned to generate image data of a saw blade and sideboards sawn from the log segments.

After processing at the primary breakdown machinery 124, the cants may be transported for further processing at the gangsaw/resaw 128. In some embodiments, a gangsaw may be used to break down the cants. In other embodiments, other machines may be used to cut the cants. For example, series band saws, commonly known as “resaws,” may be used. Such resaws may saw one or more boards at a time from the cants. In order to scan boards, a gangsaw/resaw scan zone 110 may by positioned at or further from the outfeed of the gangsaw/resaw 128.

The boards from the gangsaw or resaws and the sideboards from the primary breakdown machinery 124 may be further processed by the edger 130. The edger 130 may be associated with another scanning and optimization system and may include one or more movable saws for sawing along the length of each board. An edger scan zone 112 may be positioned downstream from the edger 130 to scan an edged board as well as edging strips.

After processing at the edger 130, the boards may be transported to the trimmer 132, where they may be trimmed to their final length for distribution as finished lumber. The trimmer 130 may be associated with yet another optimization system and may include one or more saws for trimming the boards. A trimmer scan zone 114 may be positioned downstream from the trimmer 132 to scan pieces of lumber. After processing at the trimmer 132, the pieces of lumber may be transported to a sorter 134.

### BRIEF SUMMARY

The present disclosure is directed to provide an improved method and system for cutting a log and a non-transitory computer-readable medium storing instructions for causing the cutting of a log.

A method for cutting boards from a log comprises the steps of imaging a log in a first position as the log is transported on a first apparatus, determining a preferred position for the log on a second apparatus with respect to a cutting apparatus based at least in part on the imaging of the log at the first position, moving the log to a second apparatus for transporting the log toward the cutting apparatus, wherein the log is positioned on the second apparatus based at least in part on the preferred position, imaging the log in a second position on the second apparatus, and determining that the second position deviates from the preferred position based at least in part on the imaging the log on the second apparatus.

A system for cutting boards from a log comprises a computing device and a memory. The memory is coupled to the computing device and have stored therein instructions that, upon execution on the computing device, causes the system at least to process image data representing a log in a first position as the log is transported on a first apparatus, determine a preferred position for the log on a second apparatus with respect to a cutting apparatus based in part on the image data representing the log at the first position, process image data representing the log in a second position on a second apparatus for transporting the log toward the cutting apparatus, wherein the log is positioned on the second apparatus based at least in part on the preferred position, and determine that the second position deviates from the preferred position based at least in part on the image data representing the log on the second apparatus.

A non-transitory computer-readable medium storing instructions that, upon execution on a computing device, cause a system at least to process image data representing a log in a first position as the log is transported on a first apparatus, determine a preferred position for the log on a second apparatus with respect to a cutting apparatus based in part on the image data representing the log at the first position, process image data representing the log in a second position on a second apparatus for transporting the log toward the cutting apparatus wherein the log is positioned on the second apparatus based at least in part on the preferred position, and determine that the second position deviates from the preferred position based at least in part on the image data representing the log on the second apparatus.

### BRIEF DESCRIPTION OF THE DRAWINGS

In the drawings, identical reference numbers identify similar elements. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an example of a sawmill system;

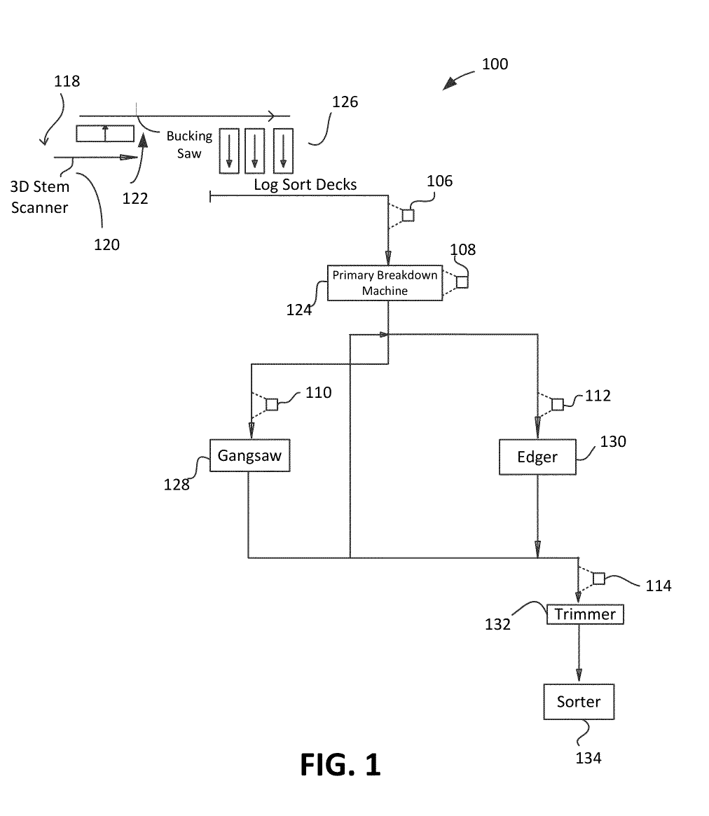

FIG. 2 is a schematic view of primary breakdown machinery according to one embodiment;

FIG. 3 is a schematic view of primary breakdown system according to one embodiment;

FIGS. 4A-4B are cross section views of an infeed conveyor engaging with a log;

FIG. 5 is a cross-sectional view of a first scan zone and an infeed conveyor engaging with a log;

FIG. 6 illustrates a sawing solution determined by a primary breakdown optimizer;

FIG. 7 shows a plan view of a log segment with an optimized solution;

FIG. 8 is the same optimized solution as the one shown in FIG. 7 but without a cant and sideboards;

FIG. 9 shows an embodiment of a C-Saw management system with upstream chip head scanners and upstream saw scanners;

FIG. 10 is schematic view of bandsaws with saw scanners;

FIG. 11 is a schematic diagram of a computing device for use in a C-Saw management system;

FIG. 12 is a flow diagram of a method of correcting log position errors by using a C-Saw management system.

### DETAILED DESCRIPTION OF ILLUSTRATIVE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lumber mills, head rigs, linebar resaws, edgers, trimmers, saws, conveyors, computing devices, imaging systems and/or laser scanners have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used herein, lumber is a broad term, referring to any piece of wood, including, for example, uncut, undebarked logs, partially processed logs, log segments, cants, sideboards, flitches, edging strips, boards, finished lumber, etc. The term, log, unless apparent from its context, is also used in a broad sense and may refer to, inter alia, uncut, undebarked logs, partially processed logs or log segments.

The headings and Abstract of the Disclosure provided herein are for convenience only and do not interpret the scope or meaning of the embodiments.

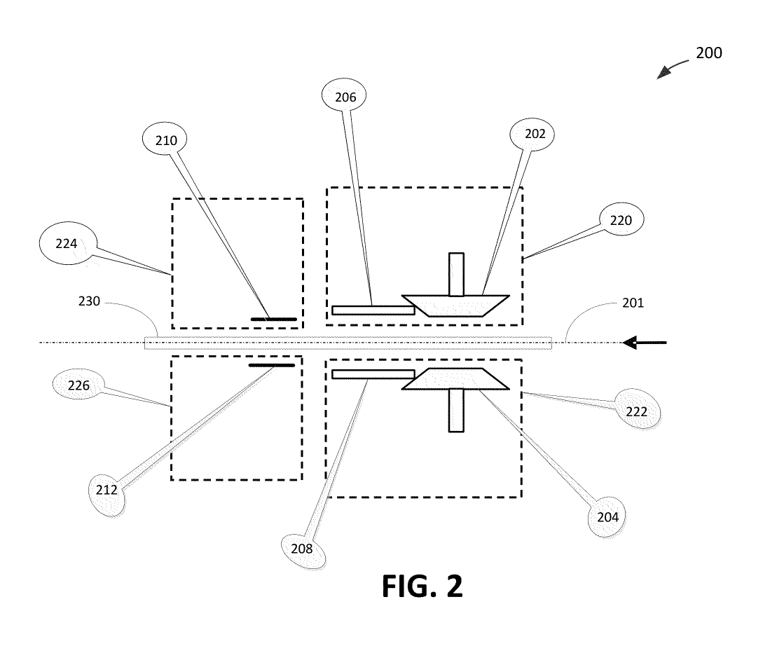

FIG. 2 illustrates primary breakdown machinery 200 according to one embodiment. The following description is based on a type of primary breakdown machinery called Canter Twin; however, the primary breakdown machinery 200 may be any other types of ones used in sawmills. As shown in FIG. 2, the primary breakdown machinery 200 includes a right chip head 202, a left chip head 204, a right chipper anvil 206, a left chipper anvil 208, a right bandsaw 210, a left bandsaw 212, a right chip head sliding base 220, a left chip head sliding base 222, a right saw sliding base 224, a left saw sliding base 226, and a sharp chain 230.

The primary breakdown machinery 200 may process a log segment, typically up to 20 feet long. The chip heads 202 and 204 may be used to remove slab wood. The bandsaws 210 and 212 may saw sideboards from a log segment. In other embodiments, round saws may replace the bandsaws 210 and 212 to saw sideboards from a log segment. The results of primary breakdown process is a cant with a width ranging typically from 4 to 12 inches and up to two sideboards which are cut from each side of a log segment. The best solution for a given log segment may involve no sideboards or a sideboard cut from only one side of a log segment.

The right chip head 202 may be mounted on the right chip head sliding base 220 which can move any distance from machinery centerline 201. Accordingly, the right chip head 202 may be adjusted to a desirable position for chipping the log segments. Likewise, the left chip head 204 may be mounted on the left chip head sliding base 222, which enables the left chip head 204 to be positioned any distance from the machinery centerline 201 for chipping the log segments. Just downstream of the right and left chip heads 202 and 204 are the right anvil 206 and the left chipper anvil 208. The anvils 206 and 208 are fixed plates and used to hold the newly chipped cant surface in position. The right bandsaw 210 may be mounted on the right saw sliding base 224; the left bandsaw 212 may be mounted to the left sliding bases 226. The right saw sliding base 224 and the left saw sliding base 226 may also be positioned to any distance from the machine centerline 201. In this way, the bandsaws 210 and 212 may be adjusted to any suitable positions to cut the log segments by moving the sliding bases 224 and 226, respectively.

The log segments are fed through the chip heads 202 and 204 and bandsaws 210 and 212 via the sharp chain 230. The sharp chain 230 may be a narrow chain having a plurality of sharp points on it top for engaging the log segments. The width of the sharp chain 230 must be narrower than the smallest cant size; so it may typically be 2.5 inches wide so that the machine can safely carry a 4-inch cant past the saws. It is notable that the actual width of a 4-inch nominal cant may be 3.6 inches, marking the bandsaws 210 and 212 less than half an inch away from the sharp chain 230 on that cant size.

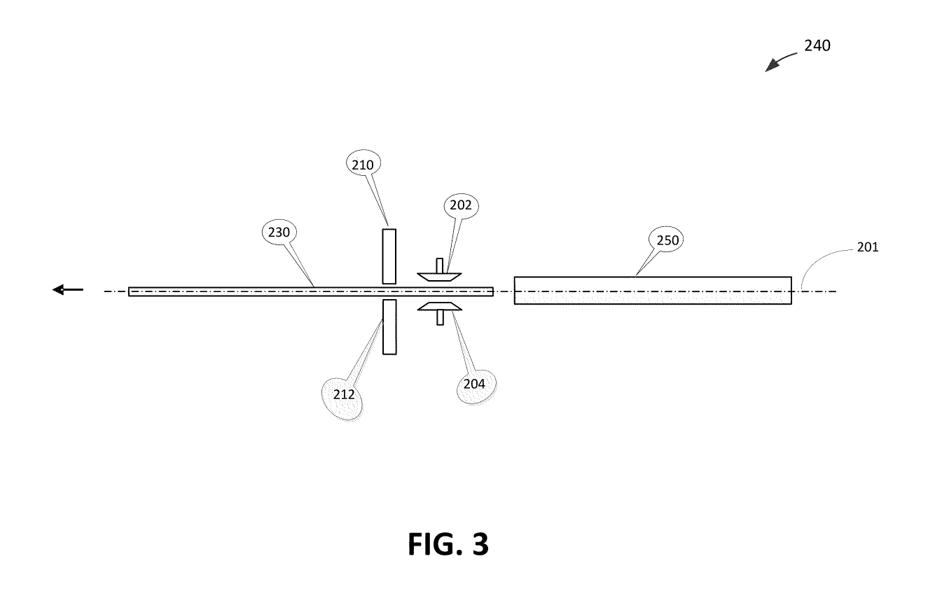

FIG. 3 illustrates an example of a primary breakdown system 240 which may be referred to as a C-Saw system. The following description is based on a type of primary breakdown system called Canter Twin Sharp Chain; however, the primary breakdown system 200 may be any other types of ones used in sawmills. The primary breakdown system 240 comprises the primary breakdown machinery 200 and an infeed conveyor 250. The primary breakdown machinery 200 and the infeed conveyor 250 may be arranged in a straight line and share the common machinery centerline 201. The structure of the primary breakdown machinery 200 has been described above. The infeed conveyor 250 may be used to hold a log segment at a known position in the X and Y planes while it moves lineally in the Z direction.

In some systems, the infeed conveyor 250 may be a long sharp chain which may transport a log segment through the log segment scan zone 106 and then directly to the chip heads 202 and 204 and the saws 210 and 212. The problem with a long sharp chain as the infeed conveyor 250 is that the position of a log segment cannot be changed after scanning. In other words, a log segment is confined to its original placement on the long sharp chain.

To overcome the limitations of a long sharp chain, the infeed conveyor 250 may be a “double length infeed” or DLI which is typically about twice as long as the longest log segment. The double length infeed allows a log segment to be scanned, optimized, and then shifted in the X axis direction to any position called for by a primary breakdown optimizer. The double length infeed can even be used to skew a log segment to a different angle. This is done by first shifting the double length infeed to a desired offset for the front end of a log segment, and then moving the double length infeed left or right to move the back end of the log segment to a different offset position. By allowing the system to have more freedom of motion, the primary breakdown optimizer may recovery more lumber from a log segment. Preferably, the infeed conveyor 250 is a double length infeed conveyor.

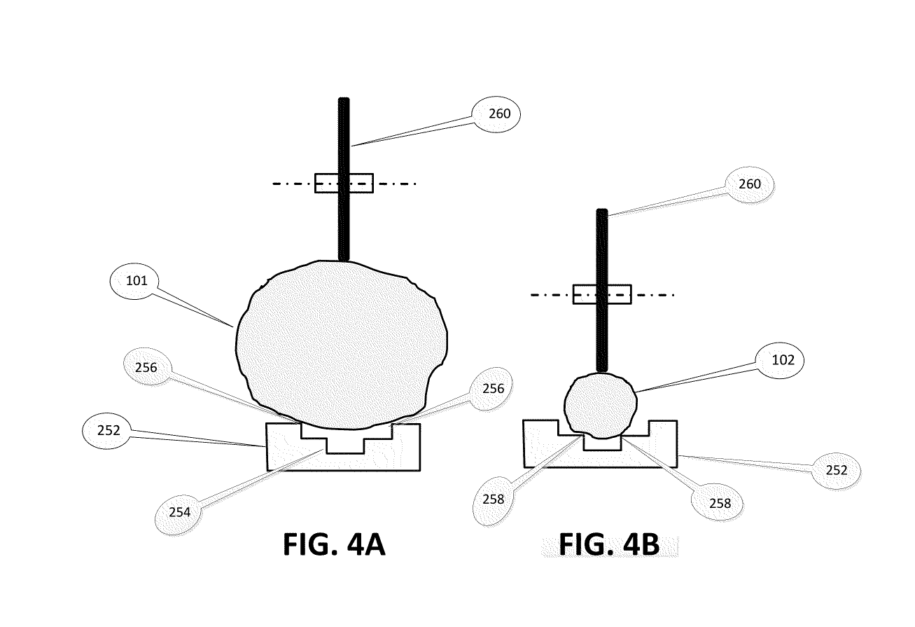

The mechanical design of the infeed conveyor 250 has been developed over many years. A typical design includes chain flights 252 as shown in FIGS. 4A and 4B. The chain flights 252 may be spaced typically 12 inches apart that are secured within guides to preclude motion in the X-Y direction. The chain flight 252 includes steps 254 to engage the bottom of a log segment so as to preclude motion of the log segment in the X-Y direction. The chain flight 252 may be made from a steel plate about one inch thick and cut with steps 254 as shown. FIGS. 4A shows a cross-sectional view of the chain flight 252 holding a big log segment; FIG. 4B shows a cross-sectional view of the chain flight 252 holding a small log segment. As shown in FIGS. 4A and 4B, a large log segment 101 may ride on upper corners 256; a small log segment 102 may ride on inner lower corners 258. A series of overhead wheels 260 may be configured to move up and down to follow the shape of a log segment. The overhead wheels 260 may be about 24 inches in diameter and have sharp teeth to engage the log segment, helping prevent the log segment's motion in the X-Y direction while the log segment is being scanned at a first scan zone 300.

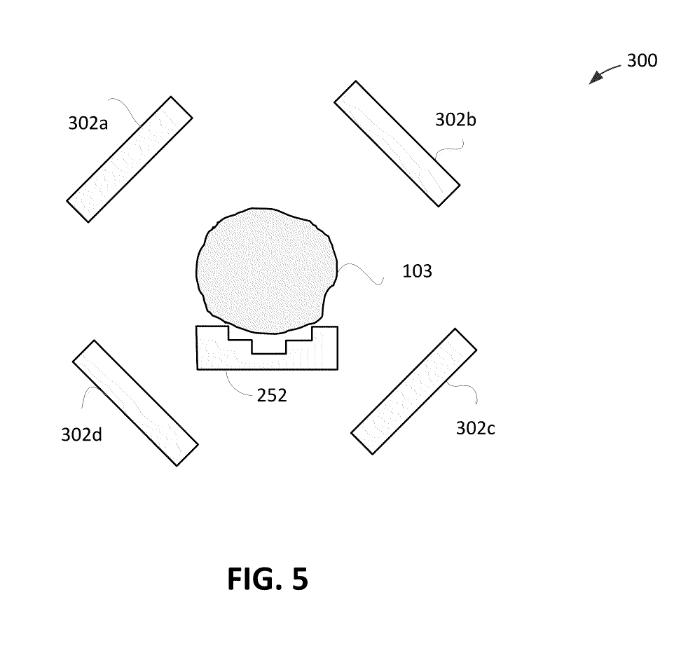

FIG. 5 is a cross-sectional view of the first scan zone 300 and the chain flight 252 (i.e. the infeed conveyor 250). As shown in FIG. 5, the first scan zone includes four laser scanners 302a, 302b, 302c, and 302d (collectively 302). These four laser scanners 302 may be spaced at 90 degrees around a log segment 103 to measure the entire size and shape of the log segment 103 as it passes through the first scan zone 300. While a four scanner configuration is illustrated in FIG. 5, the first scan zone 300 may, of course, have a different arrangement. In addition to laser scanners, different imaging systems may be used in the first scan zone 300.

The first scan zone 300 may be positioned upstream of the infeed conveyor 250. By way of example with limitation, for a mill cutting 20 feet logs, the infeed conveyor 250, a double length infeed, may be about 50 feet long. The scanners 302 at the first scan zone 300 may be positioned at about 20 feet from the leading end of the infeed conveyor 250. After the log segment 103 exits the first scan zone 300, there may be about 10 extra feet of travel to allow a primary breakdown optimizer (not shown) to orient the log segment 103 and position the equipment for desired cuts.

The laser scanners 302 may be coupled to the primary breakdown optimizer (not shown) and forward image data of the scanned log segment 103 to the primary breakdown optimizer. The primary breakdown optimizer may determine the best way to orient and cut the log segment 103 in order to extract lumber with the maximum value. Base on its determination, the primary breakdown optimizer may control the rotation and movement of the log segment 103 so as to orient the log segment at an optimum position. In some sawmills, the primary breakdown optimizer may check to see if a log segment should be skewed as it enters the process. The primary breakdown optimizer may also control the relative position of the chip heads 202 and 204 and the saws 206 and 208 with respect to the log segment 103.

A solution determined by the primary breakdown optimizer may consist of a cant width, sideboard thickness, and the offset of the log segment 103 from the machinery centerline 201, which will produce the longest and most valuable lumber. The primary breakdown optimizer may use brute force methods to simulate every possible way to position and cut the log segment 103, select the best solution, and send the solution to the systems which actually position the log segment 103, the chip heads 202 and 204, and the saws 206 and 208.

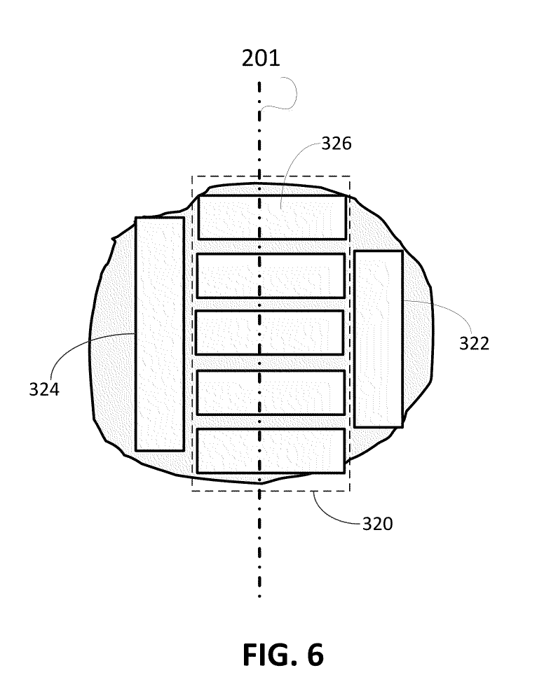

By way of example without limitation, FIG. 6 illustrates a sawing solution. As shown in FIG. 6, the primary breakdown optimizer has decided to make a center cant 320 which is 6-inch wide, a first sideboard 322 which is expected to be 2×6, and a second sideboard 324 which will be 2×8. Each board 326 which will be cut from the cant 320 is expected to be 2×6. In this example, the centerline 201 of the infeed conveyor 250 is a little to the left of the cant centerline. To execute this solution, the optimizer may instruct the first and second chip heads 202 and 204 to move to a location which is offset from the centerline 201. Similarly, the saws 210 and 212 may be instructed to position themselves closer to the centerline 201 but offset by the same amount as the chip heads 202 and 204.

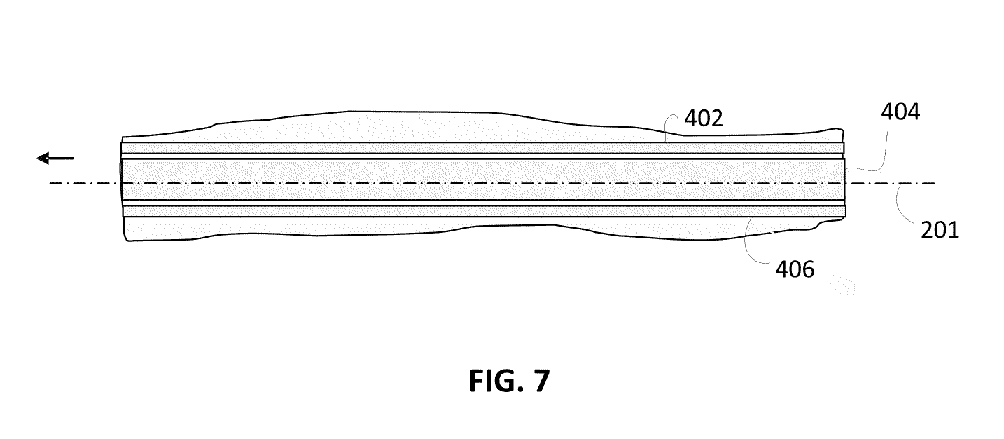

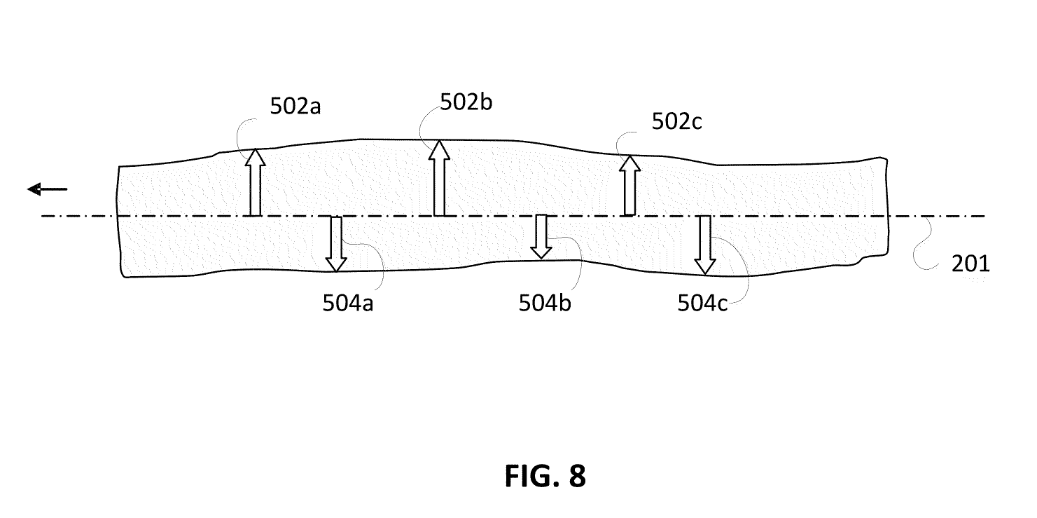

FIG. 7 shows a plan view of a log segment which has been optimized to maximize the lumber value. The optimizer decision calls for a right sideboard 402 with some specified thickness, a cant 404 of some specified width, and a left sideboard 406 with some specified thickness. The optimizer has further determined to offset the cant 404 to the right of the system centerline 201 as shown. FIG. 8 is the same optimized solution as the one shown in FIG. 7 but without the cant 402 and the sideboards 402 and 406. A detailed plan view of a log segment as it is expected to travel through the primary breakdown system may be saved inside the primary breakdown optimizer. In other words, the optimizer knows all down the length of a log the distances from the system centerline 201 to the right side 502a, 502b, and 502c (collectively 502) and the left side 504a, 504b, and 504c (collectively 504). Any deviation from this plan will reduce the value of lumber from the log.

In many sawmills, the infeed conveyor 250 may be positioned on slides which allows its movement in the X direction plus or minus about 2 inches. As mentioned above, the chip heads 202 and 204 and the saws 210 and 212 may be adjusted to any suitable positions by moving the corresponding sliding bases 220, 222, 224, and 226. In this case, sawmills may use a combination of infeed offsets and chip heads/saws offsets. The chip heads 202 and 204 and the saws 210 and 212 may be positioned an equal distance from the machinery centerline 201 as their initial positions. In other sawmills, the infeed conveyor 250 may be fixed. In this case, all of offsetting may be done by moving the chip heads 202 and 204 and the saws 210 and 212.

A serious problem with the primary breakdown system 240 is execution accuracy. No matter how sophisticated the primary breakdown optimizer may be, the results are only as good as the system's ability to carry out each solution. One accuracy problem may be caused by the handoff between the infeed conveyor 250 and the sharp chain 230. There may be about a 3 foot gap between these two conveyors due to the large diameter of the chain sprockets. To help it bridge the gap, most systems may use two vertical spiked rolls near the gap to help prevent a log segment from falling down into the gap between the infeed conveyor 250 and the sharp chain 230. However, these rolls can introduce side motion of a log segment during the handoff.

A log segment usually has an irregular shape. Therefore, the log segment may make contact with the infeed conveyor 250 at only a few points. If the sweep is turned horns down, there may be two contact points at the front end of the log segment and two contact points at the back end of the log segment. During the handoff between the infeed conveyor 250 and the sharp chain 230, the contact points of the log segment may be changed. Log position changes in the vertical direction (Y axis) may not seriously impact the value of the resulting lumber. However, movement in the horizontal direction may have a significant impact on the length, width, and value of the resulting cants and side boards. Thus, it may be very beneficial to control errors in the X axis. It has been established that a tenth inch error in log positioning in the X direction causes about a 1% recovery loss for a log segment. It is desired to have a system and method which may monitor actual log position and correct log positioning errors.

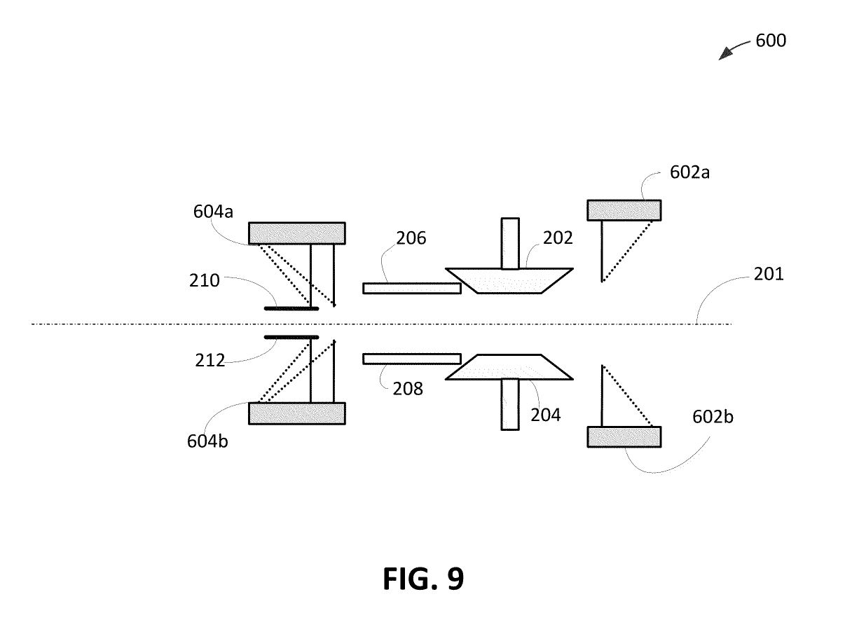

FIG. 9 shows an embodiment of a C-Saw management system 600. As shown in FIG. 9, the C-Saw management system 600 includes upstream chip head scanners 602a and 602b (collectively 602) which can image a log segment and capture its actual position on the sharp chain 230 before its entering the chip heads 202 and 204. The upstream chip head scanners 602 may be located a predetermined distance upstream of the chip heads 202 and 204, such as about 20 inches ahead of each corresponding chip head. The upstream chip head scanners 602 may be mounted to a fixed structure ahead of the chip head sliding bases 220 and 222. The upstream chip head scanners may be a pair of three dimensional laser scanners or any other suitable image acquisition devices, such as high resolution video cameras. The number of the upstream chip head scanners 602 is not limited to two; they may be at least one, three, four or any other suitable number.

As shown in FIG. 9, the C-Saw management system 600 may further include upstream saw scanners 604a and 604b (collectively 604) which can image a log segment before its being engaged by the bandsaws 210 and 212 and capture its actual position. The upstream saw scanner 604a may be located in the gap between the right chipper anvils 206 and the right bandsaw 210, such as being located about 12 inches away from the right bandsaw 210. Similarly, the upstream saw scanner 604b may be located in the gap between the left chipper anvils 208 and the left bandsaw 212, such as being located about 12 inches away from the left bandsaw 212. Since the upstream saw scanners 604 can image the sharp chain 230 along with the chipped log surfaces, the C-Saw system 600 may track the movement of the bandsaw sliding bases 224 and 226 in real time. This allows accurate dimensional measurements of chipped cants.

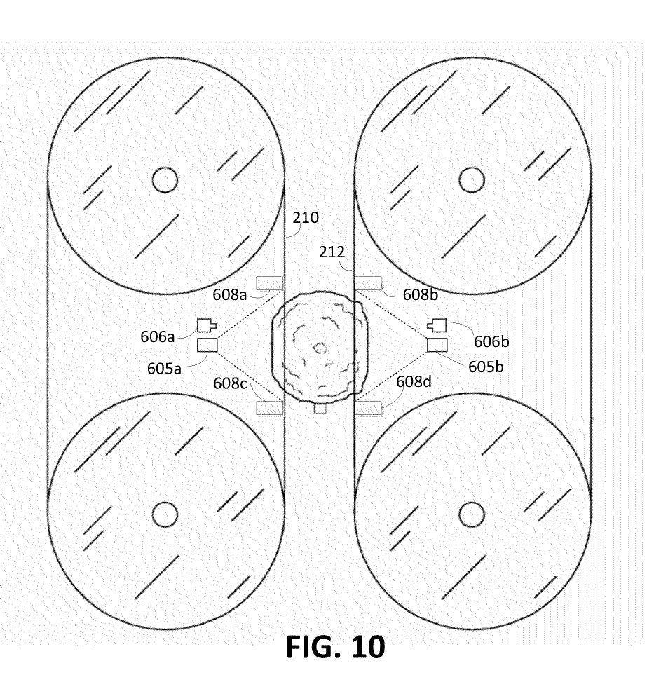

As shown in FIG. 10, the C-Saw management system 600 may further include another pair of saw scanners 606a and 606b (collectively 606) which are positioned to image the sawn board and the blades of the bandsaws 210 and 212. The upstream saw scanners 604 and the saw scanners 606 may be mounted to the corresponding bandsaw sliding bases 224 and 226. The upstream saw scanner 604a and the saw scanner 606a may be one integrated scanner unit or two separate scanner units that may be offset vertically from each other. The upstream saw scanners 604 and the saw scanners 606 may be two dimensional laser scanners with a separate or integrated light source (e.g., 605a, 605b) or any other suitable image acquisition devices, such as a CCD camera. The number of the upstream saw scanners 604 or the saw scanners 606 is not limited to two; they may be four or any other suitable number.

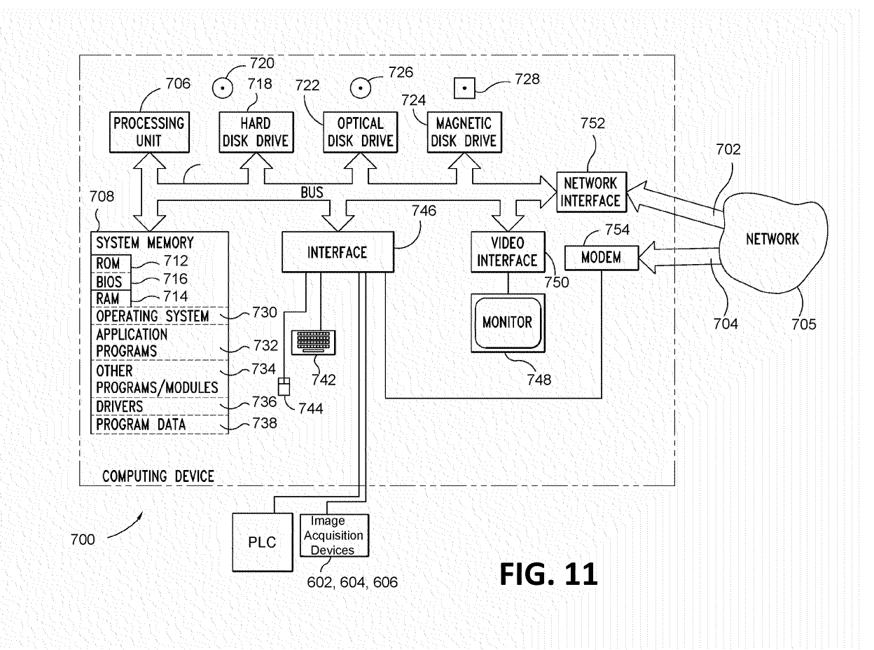

The C-Saw management system 600 may further include a computing device 700 (as shown in FIG. 11) which is coupled the upstream chip head scanners 602, the upstream saw scanners 604, and the saw scanners 606 to receive image data, including actual log position information. The computing device may communicate with the primary breakdown optimizer for receiving expected log position data.

As shown in FIG. 11, the computing device 700 may be coupled by one or more communications channels/logical connections 702 and 704 to a network 706. For instance, when used in a WAN networking environment, the computing device 700 may include a modem 754 for establishing communications over the WAN 704. Alternatively, another device, such as the network interface 752 (communicatively linked to the system bus 710), may be used for establishing communications over the WAN 702. The modem 754 is shown in FIG. 11 as communicatively linked between the interface 746 and the WAN 704. However, in other embodiments, the computing device 700 need not be coupled to a network.

The computing device 700 includes a processing unit 706, a system memory 708, and a system bus 710 that couples various system components including the system memory 708 to the processing unit 706. The processing unit 706 may be any logic processing unit, such as one or more central processing units (CPUs), digital signal processors (DPS), etc. The system bus 710 can employ any known bus structures or architectures, including a memory bus with memory controller, a peripheral bus, and a local bus. The system memory 708 includes read-only memory (“ROM”) 712 and random access memory (“RAM”) 714. A basic input/output system (“BIOS”) 716, which can form part of the ROM 712, contains basic routines that help transfer information between elements within the computing device 700, such as during start-up.

The computing device 700 also includes a hard disk drive 718 for reading from and writing to a hard disk 720, and an optical disk drive 722 and a magnetic disk drive 724 for reading from and writing to removable optical disks 726 and magnetic disks 728, respectively. The optical disks 726 can be a CD or a DVD, while the magnetic disk 728 can be a magnetic floppy disk or diskette. The hard disk drive 718, optical disk drive 722, and magnetic disk drive 724 communicate with the processing unit 706 via the system bus 710. The drives 718, 722, 724, and their associated computer-readable media 720, 726, 728, provide nonvolatile storage of computer-readable instructions, data structures, program modules and other data for the computing device 700. Although the depicted computing device 700 employs hard disk 720, optical disk 726, and magnetic disk 728, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 708, such as an operating system 730, one or more application programs 732, other programs or modules 734, drivers 736, and program data 738. While shown in FIG. 11 as being stored in the system memory 708, the operating system 730, one or more application programs 732, other programs or modules 734, drivers 736, and program data 738 can be stored on the hard disk 720 of the hard disk drive 218, the optical disk 726 of the optical disk drive 722 and/or the magnetic disk 728 of the magnetic disk drive 724. A user can enter commands and information into the computing device 700 through input devices such as a touch screen or keyboard 742 and/or a pointing device such as a mouse 744. These or other input devices are connected to the processing unit 706 through an interface 746 such as a universal serial bus “USB” interface that couples to the system bus 710, although other interfaces such as a parallel port, a game port or a wireless interface or a serial port may be used. A monitor 748 or other display device is coupled to the system bus 710 via a video interface 750, such as a video adapter. Although not shown, the computing device 700 can include other output devices, such as speakers, printers, etc.

In addition to being coupled to scanners 602, 604, 606, the computing device 700 is further coupled to a programmable logic controller (PLC) which can receive instructions from the computing device 700 for controlling machinery. By way of example without limitation, based on the instructions from the computing device 700, the PLC may adjust the positions of the chip heads 202 and 204 and bandsaws 210 and 212 so as to ensure that a log segment is correctly positioned relative to the chip heads and bandsaws. The instructions for processing data from the scanners 602, 604, 606, and the primary breakdown optimizer, making determinations based on relevant data, controlling machinery may be stored in the system memory 708 and/or any suitable non-transitory computer-readable medium, such as the hard disk 720, the optical disks 726, and the magnetic disk 728.

The data from the upstream chip head scanners 602, the upstream saw scanners 604, and the saw scanners 606 may be used for various purposes. As mentioned above, a minor error in positioning a log in the X direction may cause a considerable recovery loss for the log. The data from the upstream chip head scanners 602, the upstream saw scanners 604, and the saw scanners 606 may be used to correct log position errors so as to eliminate transport accuracy losses.

The computing device may receive the detailed plan view data of a log segment as it is expected to travel through the primary breakdown system from the primary breakdown optimizer. The upstream chip head scanners 602 may capture the actual position of a log segment before its being chipped. Upon receiving data from the upstream chip head scanners 602, the computing device may compare the actual log position to the expected log position so as to check whether a log segment deviates from its expected position. If any position deviation exists, the computing device may convert the difference between the actual position and the expected position into a plus or minus offset. If the offset is within a reasonable range (for example plus or minus 0.2 inches), the computing device may send instructions, which typically consist of numbers, to the programmable logic controller (PLC). Based on the instructions, the PLC may control the chip head sliding bases 220 and 222 so as to move the corresponding chip heads 202 and 204 to ensure that a log segment is correctly positioned relative to the chip heads 202 and 204. In this way, the C-Saw management system can significantly eliminate transport accuracy problems caused by the handoff between the infeed conveyor 250 and the sharp chain 230.

The upstream saw scanners 604 may image the chipped surfaces and the actual position of a log segment when it is transported between the chip heads and the bandsaws. The saw scanners 606 may image the sawn board, the blades of the bandsaws 210 and 212, and the actual position of a log segment as it is sawn. Based on the data received from the upstream saw scanners 604 and the saw scanners 606, the computing device may compare the actual log position to the expected log position. If any position deviation exists, the computing device may send instructions to the PLC. According to the instructions, the PLC may control the saw sliding bases 220 and 222 which may move the corresponding bandsaws 210 or 212 to ensure that the log segment is correctly positioned relative to the bandsaws 210 and 212. Such changes may include adjustments in the X direction, or speeding up or slowing down the approach of the log segment in the Z direction towards the bandsaws 210 and 212.

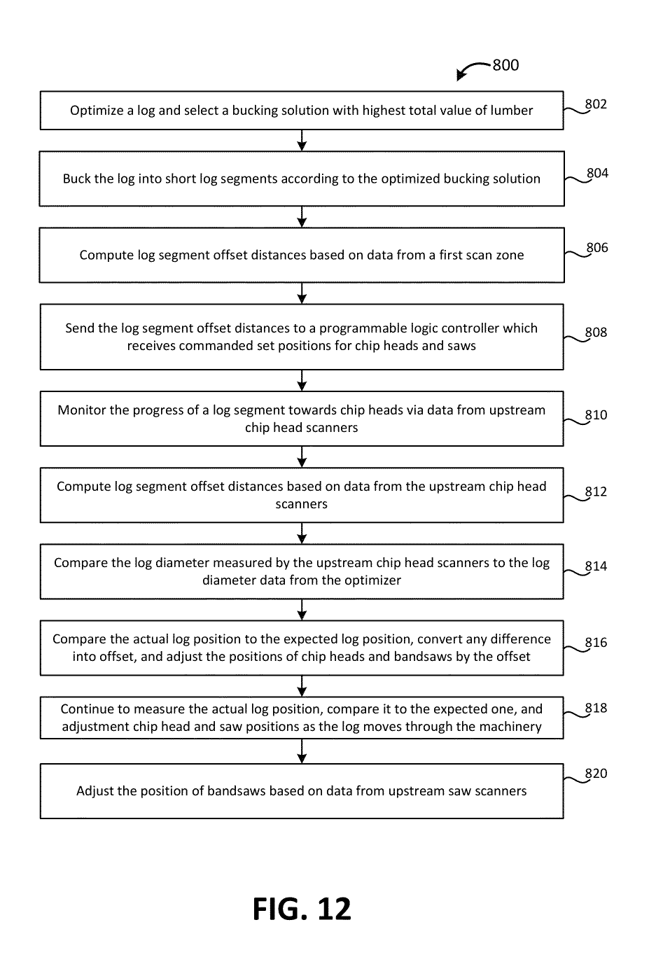

FIG. 12 shows a method 800 of correcting log position errors by using the C-Saw management system 600.

At 802, a computer optimizer of a sawmill system may optimize a log in an usual manner, such as using brute force methods, and select the bucking solution with the highest total value of lumber, taking chips into account.

At 804, the log may be transported to one or more bucking saws so as to be bucked up into short log segments according to the best bucking solution determined by the computer optimizer.

At 806, for each log segment, a primary breakdown optimizer may compute the average distance from a machinery centerline to the left and right outside of the log segment (i.e. segment offset distance) based on data from a first scan zone.

At 808, the primary breakdown optimizer may send the segment offset distances to a programmable logic controller (PLC). Meanwhile, the PLC may receive commanded set positions for chip heads and saws.

At 810, a computing device of a C-Saw management system which is connected to the PLC may monitor the progress of a log segment towards primary breakdown machinery via data from upstream chip head scanners. By the time the log segment reaches the upstream chip head scanner heads, the C-Saw management system may receive the plan view data of the log segment from the primary breakdown optimizer.

At 812, the upstream chip head scanners may begin scanning the front of the log segment. After the log has traveled a short distance, such as 12 inches, the computing device may compute an average distance from the outside of the log segment to the machinery centerline based on the data from the upstream chip head scanners.

At 814, the C-Saw management system may compare the log diameter measured by the upstream chip head scanners to the log diameter data from the primary breakdown optimizer. They should match very closely. Otherwise, it is likely to have a scanner accuracy issue which needs to be tracked down and fixed. If the log diameter data is good, go on to the next step.

At 816, the C-Saw management system may compare the actual log position to the expected log position. The C-Saw management system may convert the difference between the actual log position and the expected log position into a plus or minus offset. If the offset is within a reasonable range, such as plus or minus 0.2 inches, the C-Saw management system may instruct the PLC to immediately adjust the positions of chip heads and the positions of bandsaws by the amount of the offset.

At 818, the C-Saw management system may continue to measure actual log position and compare it to the expected log position all down the length of the log segment. Based on the comparison results, the C-Saw management system may control movement of chip head sliding bases so as to make adjustments to the chip head and saw positions as the log segment moves through the machinery, whereby ensuring that the log segment is correctly positioned relative to the chip heads 202 and 204 and the bandsaws. By the way of example without limitation, a reasonable limit may be 0.010 inches per 6 inch segment. This would allow the offset to start out at +0.2 inches and end up at −0.2 inches on the other end of a 20 foot log.

At 820, the C-Saw management system may make adjustments to the positions of bandsaws based on the data from upstream saw scanners. It may happen before the log reaches the bandsaws. As the chipped surface reaches the upstream saw scanners, the C-Saw management system may make small adjustments to the saw positions to maintain the correct sideboard thickness. In this way, the system may correct the saw positions in response to three kinds of errors: (1) log transport errors ahead of the chip heads, (2) movement in the X direction that happens between the chip heads and the saws, and (3) deflection of the saw blade that happens due to saw condition, log grain direction, sawing speeds, etc.

In addition to correcting log position errors so as to eliminate transport accuracy losses, the data from the upstream chip head scanners 602, the upstream saw scanners 604, and the saw scanners 606 may be used to control the position of top saw guides 608a, 608b.

In order to stabilize the blades of the bandsaws 210 or 212, two pairs of saw guides (608a, 608b, 608c, 608d) may be positioned above and below a log segment. The top saw guide may be adjustable and can move up and down with log diameter. If the top saw guide is too low, the log may hit the guide and either damage it or create downtime. The top saw guide may be designed to rotate up out of the way if it is hit; however, the mill has to stop the machinery and put it back in position. Because the result of hitting the top saw guide is so severe, most mills are pretty conservative about where the top saw guide is located. In the most aggressive mills, the guide may be positioned about 4 inches above the log. In some systems, the guide may move vertically to follow the log shape during the sawing process. However, most mills play it conservative and keep the guide at least 10 inches above the log. This reduces sawing accuracy because the saws 210 or 212 may then be allowed to flex in the X direction. The closer the guide is to the log, the more accurate the cut.

In the old systems, the guide setting may be determined by the primary breakdown optimizer, taking into account the log diameter and expected height about the sharp chain 230. Often the system just looks for the highest point all along the log, adds about 6 inches, and then sets both guides to that position and leaves them there for the entire log. This old arrangement may decrease the cut accuracy. The C-Saw system 600 with upstream chip head scanners 602, the upstream saw scanners 604, and the saw scanners 606 can allow much more aggressive guide placement and control, whereby increasing the cut accuracy.

The handoff between the infeed conveyor 250 and the sharp chain 230 may often change log position in the Y direction. This is because the ends of a sleepy log may or may not fall between two chain flights. In some cases, the log may be lifted up 2 inches or more as it transitions to the sharp chain 230 from the infeed conveyor 250. The upstream chip head scanners 602 may observe exactly where the guide can safely be located because it may see the final position of the log after it transitions to the sharp chain 230. The upstream saw scanners 604 may confirm that everything is still okay. The saw scanner 606 may extend high enough above the log so that it can see the guide itself while the saw is in the cut. The data from the upstream chip head scanners 602, the upstream saw scanners 604, and the saw scanners 606 can be used to set up a feedback loop control circuit that positions the guide very close to the wood in a safe manner. The C-Saw system 600 may be able to easily determine the value of aggressive saw guide placement. The C-Saw could switch the saw guide back and forth between a high guide position, such as 10 inches, and a low guide position, such as 3 inches, and observe the impact on saw deflection.

The data from the upstream chip head scanners 602 may also be used to control saw entry speeds.

Traditional saw entry speed control methods based on saw deflection must first gather data at the front of the log before beginning to make speed changes. Typically people have seen about a foot or two of saw deflection at the beginning of the log. It is because people don't really know what to expect in advance. Sawing speeds are usually set by the primary breakdown optimizer using a simple lookup table. It computes the expected depth of cut down the length of the log, and then looks up the proper speed in a table arranged by saw depth. Most systems just select one speed and stick with it but some try to change speeds during the log based on taper. For example, if the large end of the log enters the saw first, it might have to go slow for a foot or two and can then ramp up the speeds due to the smaller and smaller log going through.

The differences people observe from log to log when it comes to saw deflection seems to be related mostly to the differences between logs. Some are easy to cut while others are much harder to cut. This seems reasonable due to different growing conditions, spacing, moisture etc. within the forest. Then again some logs are cut very soon after they have been harvested, while others might sit around and dry out a bit, making them harder to cut.

The C-Saw system 600 may use the date from the upstream chip head scanners 602 in conjunction with the data gained from sensors on the chip heads 202 and 204 and the saws 210 and 212 to compute exactly how many cubic inches of chips is being produced by each head over a specific length of the log. For example, it is assumed that the C-Saw system 600 will analyze the first 2 feet. It computes the volume in cubic inches and then notes the power (e.g., total number of Watts) which will be consumed while chipping the first 2 feet. From this, the system may compute a “log toughness” index that will vary from log to log. The C-Saw 600 may then correlate the toughness index with the behavior of the saws, using real time saw deflection data. In this way, the C-Saw system 600 may forecast what the saws 210 and 212 will do prior to the log's arrival at the saw blades, and then adjust the entering speed to ensure good results while maintaining the highest possible speeds. It's possible that the chip heads 202 and 204 due to their mass might slow down a bit while chipping, and that people can monitor that behavior as a way to contribute to a more accurate log toughness score.

The data from the upstream chip head scanners 602 and the upstream saw scanners 604 may also be used for detecting knots of a log so as to prevent sawing problems.

It has been observed that when a bandsaw hits a section of the log with many large knots, it can cause sawing issues. In extreme cases it can even cause the saw to move so far that it hits the sharp chain and wrecks a $1000 saw in the process while causing about an hour of downtime.

The C-Saw system may use the data from the upstream chip head scanners 602 to monitor the log for what are called “knot indicators”. Basically they are bumps that form when a branch falls off of a tree, that slowly go away when the trees continues to grow. Of course if there are branch stubs that were created during delimbing in the woods, the scanners 602 will have no problems seeing them.

The upstream saw scanners 604 may be able to use its gray scale data to see knots that are below the surfaces of the log. This can be used to help tune the algorithms for knot detection from the upstream chip head scanners 602. By getting knot data early enough, sawing problems caused by log knots may be prevented by adjusting sawing speeds or taking other suitable measures.

The data from the upstream chip head scanners 602 may further be used for better speed control.

Traditionally the optimizer controls the speeds based on its knowledge of log shape and the sawing solution. This is usually based on two simple tables. The first is based on the amount of chipping to do, and limits the speeds to what the chip heads can handle. Most often the chipping speeds can be quite high (450 fpm) and still work.

The sawing speeds are usually controlled based on a simple lookup table for depth of cut. On large logs the speeds are generally in the 200 to 250 fpm range, and on small logs the sawing speeds can approach 350 fpm. This table is generally based on the notion of gullet fill. Basically when a tooth enters the log it begins making shavings that break apart to become sawdust. The thickness of this particle depends on how fast the bandsaw is moving coupled with how fast the log is advancing into the cut. The goal is to prevent the gullet from filling with sawdust before it reaches the bottom of the log where it can spill the sawdust out. If the gullet fills up before that, the sawdust will be forced to spill out into the kerf area which heats up the saw.

A normal fill ratio target is 70%. So the saw designers will try to arrange the speeds so that the gullet fill ratio is maintained over the range of log diameters. The problem with fill ratio is that it is not the only factor that affects the saw deflection behavior. Other factors may include degree of sharpness, angle of the log surface to the saw blade, amount of saw strain, toughness of the wood, etc.

Based on the data from the upstream chip head scanners 602, the C-Saw system 600 can take over the speed control job entirely from the optimizer. So the logs may be allowed to reach the upstream chip head scan zone at full speed, such as 600 fpm, and then the C-Saw system 600 may automatically slow down the feed rate based on what is forecast to happen according the recent data from the upstream chip head scanners 602. Smoothing of this data over time can lead to better sawing accuracy and also higher average throughput.

The data from the upstream chip head scanners 602, the upstream saw scanners 604, and the saw scanners 606 may still be used to control the gap between logs so as to improve production capacity.

By the way of example without limitation, the average gap between logs in mills may be about 10 feet. There is wasted production capacity if the gap could have been smaller between any two given logs. Based on the data from the upstream chip head scanners 602 and the upstream saw scanners 604, the C-Saw system 600 may advantageously reduce gaps to the minimum amount.

One way to reduce the gap is to safely move the saws earlier using bandsaw data. When the next log is bigger, the saws usually have to move out to a bigger cant size. But existing systems play it safe when it comes to timing the shift. The saws are inhibited from moving until upstream and downstream photocells have been cleared. Since the saw blade is about 10 inches wide, the old system must wait for the log to clear the back of the saw entirely before it sees that it is safe to move the saw.

The saw scanners 606 may observe exactly when the sideboard falls away from the log. This information can be used to give a more precise signal to the PLC that it is okay to move the saw away from the cant. The old logic may have to be maintained for set changes that move the saws towards the machine center, because the entire cant has to clear the bandsaws 210 and 212 before that move is safe.

The conservative way to manage gaps is to require that all of the chip heads and saws are in their new positions before a log is allowed to enter the machinery. A more aggressive approach is to predict when the chip head will arrive at its new set position, and then close the gap until the log arrives just at the same time as the chip heads reaches set. The C-Saw system 600 may monitor the set completion times for the chip heads 202 and 204 and saws 210 and 212 in real time, and adjust tables that reflect the current speed capability. Then it may determine the smallest possible gap and execute it by instructing the infeed conveyor 250 and the sharp chain 230 exactly what speed to use and also when to put on the brakes.

The advantage of the above approach is that the upstream saw scanners 604 may observe and track the amount of front end sniping. Snipe is caused by a chip head or saw moving while in the cut, at the very beginning of a log. By monitoring snipe directly, people can aggressively tune the gap controls until they see some snipes and then back off a bit. To do this, the system 600 may need to control the speed of the double length infeed 250 and the sharp chain 230 directly. Most of the time the infeed speed matches the sharp chain speed. But when the gap between two logs shows up in the break between the conveyors, it is okay to slow down or speed up the infeed chain to either pull up more gap or shorten an existing one.

Although not required, the embodiments have been described in the general context of computer-executable instructions, such as program application modules, objects, or macros being executed by a computer. Those skilled in the relevant art will appreciate that the illustrated embodiments as well as other embodiments can be practiced with other computer system configurations, including handheld devices, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable medium for use by or in connection with any computer and/or processor related system or method. In the context of this document, a memory is a computer readable medium that is an electronic, magnetic, optical, or other physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but is not limited to, an electronic, magnetic, optical, electromagnetic, infrared, or semiconductor system, apparatus, device, or propagation medium. More specific examples (a nonexhaustive list) of the nontransitory computer- or processor-readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), and a portable compact disc read-only memory (CDROM).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Pat. No. 7,853,349; U.S. Pat. No. 7,866,642; U.S. patent application Ser. No. 11/873,090 filed Oct. 16, 2007; U.S. patent application Ser. No. 12/424,402 filed Apr. 15, 2009 (published as US-2009-0255607); U.S. provisional patent application Ser. No. 61/450,011 filed Mar. 7, 2011; and U.S. patent application Ser. No. 13/366,028 filed Feb. 3, 2012 are incorporated herein by reference, in their entirety. Aspects of the embodiments can be modified, if necessary, to employ systems, circuits and concepts of the various patents, applications and publications to provide yet further embodiments.

Different arrangements of laser scanners may also be used to determine geometric characteristics of the boards. The laser scanners may also be positioned at still other locations downstream from the linebar resaw. Different imaging systems other than laser scanners may alternatively or additionally be used. The light source may comprise another collimated, non-laser light source or another, more diffuse source of electromagnetic radiation. The image sensor may also take variety of other forms.

The methods described herein may include additional acts, may omit some acts, and may perform or execute the acts in a different order than illustrated or described.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

What is claimed:

1. A method for cutting boards from a log, comprising:
imaging a log in a first position as the log is transported on a first apparatus;
determining a preferred position for the log on a second apparatus with respect to a cutting apparatus based in part on the imaging of the log at the first position;
moving the log to a second apparatus for transporting the log toward the cutting apparatus, wherein the log is positioned on the second apparatus based at least in part on the preferred position;
imaging the log in a second position on the second apparatus; and
determining that the second position deviates from the preferred position based at least in part on the imaging the log on the second apparatus.

2. The method of claim 1 wherein the first apparatus comprises a conveyor and the second apparatus comprises a sharp chain.

3. The method of claim 1 wherein the preferred position is based at least in part on a computed simulation of a plurality of boards to be cut from the log.

4. The method of claim 1 wherein the cutting apparatus comprises at least one of a chipper and a band saw.

5. The method as recited in claim 4 wherein the log is positioned relative to at least one of the chipper and the band saw based at least in part on determining that the second position deviates from the preferred position.

6. The method as recited in claim 4 wherein at least one of the chipper and the band saw are automatically repositioned.

7. The method as recited in claim 1 wherein the imaging the log in the second position comprises receiving image data from an imaging device proximate the second apparatus disposed a predetermined distance in front of the cutting apparatus.

8. A system for cutting boards from a log, comprising:
a computing device;
a memory coupled to the computing device, said memory having stored therein instructions that upon execution on the computing device, causes the system at least to:
process image data representing a log in a first position as the log is transported on a first apparatus;
determine a preferred position for the log on a second apparatus with respect to a cutting apparatus based in part on the image data representing the log at the first position;
process image data representing the log in a second position on a second apparatus for transporting the log toward the cutting apparatus, wherein the log is positioned on the second apparatus based at least in part on the preferred position; and
determine that the second position deviates from the preferred position based at least in part on the image data representing the log on the second apparatus.

9. The system as recited in claim 8 wherein the first apparatus comprises a conveyor and the second apparatus comprises a sharp chain.

10. The system as recited in claim 8 further comprising instructions stored in the memory that upon execution on the computing device cause the system to compute a simulation of a plurality boards to be cut from the log to determine the preferred position.

11. The system as recited in claim 8 wherein the cutting apparatus comprises at least one of a chipper and a band saw.

12. The system as recited in claim 11 comprising a mechanism for positioning the log relative to at least one of the chipper and the band saw based at least in part on the determination that the second position deviates from the preferred position.

13. The system as recited in claim 12 wherein the mechanism for positioning the log relative to the at least one of the chipper and the band saw comprising generating instructions that cause the at least one of the chipper and the band saw to be automatically repositioned.

14. The system as recited in claim 8 further comprising an imaging device proximate the second apparatus disposed a predetermined distance in front of the cutting apparatus.

15. The system as recited in claim 14 wherein the imaging device comprises a laser.

16. A non-transitory computer-readable medium storing instructions that upon execution on a computing device at least:
process image data representing a log in a first position as the log is transported on a first apparatus;
determine a preferred position for the log on a second apparatus with respect to a cutting apparatus based in part on the image data representing the log at the first position;
process image data representing the log in a second position on a second apparatus for transporting the log toward the cutting apparatus, wherein the log is positioned on the second apparatus based at least in part on the preferred position; and
determine that the second position deviates from the preferred position based at least in part on the image data representing the log on the second apparatus.

17. The non-transitory computer-readable medium as recited in claim 8 further storing instructions that upon execution on the computing device at least compute a simulation of a plurality boards to be cut from the log to determine the preferred position.

18. The non-transitory computer-readable medium as recited in claim 16 wherein the cutting apparatus comprises at least one of a chipper and a band saw.

19. The non-transitory computer-readable medium as recited in claim 18 further storing instructions that upon execution on the computing device at least generate information for positioning the log relative to at least one of the chipper and the band saw based at least in part on the determination that the second position deviates from the preferred position.

20. The non-transitory computer-readable medium as recited in claim 19 wherein the instructions for positioning the log relative to the at least one of the chipper and the band saw comprising generating instructions that cause the at least one of the chipper and the band saw to be automatically repositioned.
